(19) United States
(12) Patent Application Publication
(10) Pub. No.: US 2008/0074348 A1
(43) Pub. Date: Mar. 27, 2008

(54) LIGHT-EMITTING APPARATUS AND DRIVING CIRCUIT THEREOF

(75) Inventor: Chin-Fa Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/609,336

(22) Filed: Dec. 12, 2006

(30) Foreign Application Priority Data
Sep. 27, 2006 (TW) 95135749

(51) Int. Cl. G09G 3/14

(52) U.S. Cl. 345/46

(57) ABSTRACT

An apparatus for driving an LED includes a power conversion module and a protection module. The power conversion module shifts the potential of an input voltage upward or downward according to a duty cycle of a PWM signal, and outputs a driving signal to drive the LED. In addition, the protection module determines a state of a protection signal to control the operation of the power conversion module according to the potential of the driving signal. When the potential of the driving is greater than a first preset value and smaller than a second preset value, the power conversion module is controlled to stop outputting the driving signal. When the potential of the driving signal is not greater than the first preset value and not smaller than the second preset value, the power conversion module is controlled operating normally.

### CROSS-REFERENCE TO RELATED APPLICATION

This application claims the priority benefit of Taiwan application serial no. 95135749, filed Sep. 27, 2006. All disclosure of the Taiwan application is incorporated herein by reference.

### BACKGROUND OF THE INVENTION

1. Field of the Invention

The present invention relates to a driving circuit of a light source, and more particularly to a driving circuit of an LED.

2. Description of Related Art

Light emitting diodes (LED) capable of converting electric energy into luminous energy has been gradually used as light sources in various illumination sites or backlight modules of consumable electronic products. Generally speaking, in order to enable an LED to provide a stable light source, a DC-DC power converter is usually designed to provide a stable DC power to the LED.

FIG. 1 is a circuit diagram of a conventional DC-DC power converter. Referring to FIG. 1, the conventional power converter 100 includes an inductor 102, a transistor 104, a diode 106, and a capacitor 108. One terminal of the inductor 102 receives an input voltage VIN1, another terminal of the inductor 102 is coupled to a first source/drain terminal of the transistor 104 and an anode terminal of the diode 106, and a cathode terminal of the diode 106 is grounded through the capacitor 108. Moreover, a second source/drain terminal of the transistor 104 is grounded, and a gate terminal of the transistor 104 receives a pulse width modulation (PWM) signal SP1, wherein a duty cycle of the PWM signal SP1 is determined by an operating current of the LED driven by the power converter 100.

When the PWM signal SP1 is at a high potential, the transistor 104 is in an ON state, and at this time, the inductor 102 starts to store the electrical power transmitted with the input voltage VIN1. Since the potential of the coupling node of the inductor 102 and diode 106 is grounded, the diode 106 is in an OFF state. When the PWM signal SP1 is at a low potential, the transistor 104 is turned off. At this time, due to the characteristic of continuous current of the inductor 102, the potential of the node of the inductor 102 and the diode 106 is elevated, such that the diode 106 is turned on and the energy stored in the inductor 102 starts to be transmitted to the capacitor 108 for storage and drive the LED to emit light. When the PWM signal SP1 changes into a high potential again, the capacitor 108 releases the stored energy to enable the LED to continuously emit light, and the inductor 102 stores the energy again for providing the same to the capacitor 108 and the LED. Repeated cycle of a voltage higher than the input voltage VIN1 can be used to drive the LED.

For example, if VIN=12V, a driving signal DS1 higher than 12V can be provided through power converter 100, the threshold voltage of white LED is about 3.5 V. When four (or more) LEDs are connected in series, a driving signal DS1 of 14V (or above) is needed, which can be provided by the abovementioned power converter 100. However, the step-up power converter 100 cannot be used when three (or less) LEDs connected in series need to be driven.

Although the conventional power converter can convert the potential of the input voltage into a higher potential, the potential of the input voltage cannot be converted into a lower potential. Therefore, in some technologies, a step-down circuit is used as a power converter. However, neither the step-up circuit nor the step-down circuit can satisfy the load requiring a high voltage and the load requiring a low voltage.

### SUMMARY OF THE INVENTION

Accordingly, the present invention is directed to a driving circuit of an LED for driving a LED load requiring a high voltage and a LED load requiring a low voltage.

The present invention provides a driving circuit of an LED comprising a first inductor, a first capacitor, a switch, a second inductor, a diode, a second capacitor, a load detector, and a signal generating unit. A first terminal of the first inductor is coupled to an input voltage, and a first terminal of the first capacitor is coupled to a second terminal of the first inductor. The switch determines whether or not to couple the second terminal of the first inductor to ground according to a PWM signal. A first terminal of the second inductor is coupled to a second terminal of the first capacitor, and a second terminal of the second inductor is grounded. An anode terminal of the diode is coupled to the second terminal of the first capacitor. A first terminal of the second capacitor is coupled to a cathode terminal of the diode and a light source module so as to provide a driving signal to the light source module, and a second terminal of the second capacitor is grounded, wherein the light source module has at least one LED. The load detector detects a current of the light source module to output a feedback signal. The signal generating unit is coupled to the load detector and generates the PWM signal according to the feedback signal. The driving circuit further comprises a protection module for determining whether or not to output a protection signal according to whether the potential of the driving signal is greater than a first preset value and smaller than a second preset value, so as to control the power conversion module stopping outputting the driving signal.

According to another embodiment of the present invention, a light-emitting apparatus comprising a light source module, a power conversion module, and a protection module is provided. The light source module comprises at least an LED, and the power conversion module steps up or steps down an input voltage to generate a driving signal to drive the light source module according to a duty cycle of the PWM signal. Furthermore, the protection module determines a state of the protection signal to control the operation of the power conversion module according to the potential of the driving signal.

The power conversion module of the present invention can step up or step down the potential of the input voltage according to the duty cycle of the PWM signal. Therefore, the present invention can satisfy an LED load requiring a high voltage or an LED load requiring a low voltage at the same time.

In order to the make aforementioned and other objects, features and advantages of the present invention comprehensible, preferred embodiments accompanied with figures are described in detail below.

### BRIEF DESCRIPTION OF THE DRAWINGS

FIG. 1 is a circuit diagram of a conventional DC-DC power converter.

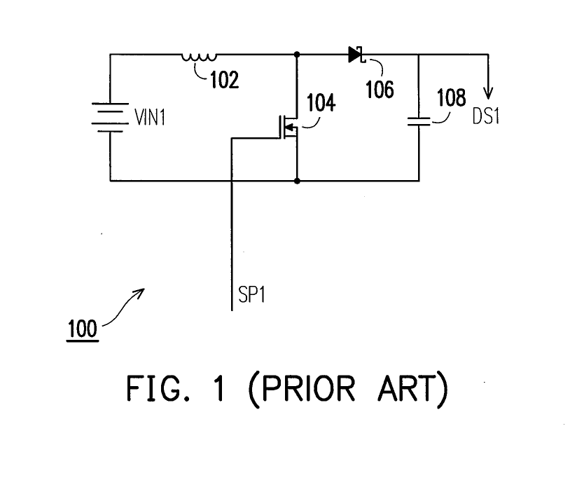

FIG. 2 is a circuit diagram of a light-emitting apparatus according to a preferred embodiment of the present invention.

FIG. 3 is a timing diagram of a PWM signal according to a preferred embodiment of the present invention.

FIG. 4 is a circuit diagram of a signal generating unit according to a preferred embodiment of the present invention.

FIG. 5 is a timing diagram of a protection function according to a preferred embodiment of the present invention.

### DESCRIPTION OF EMBODIMENTS

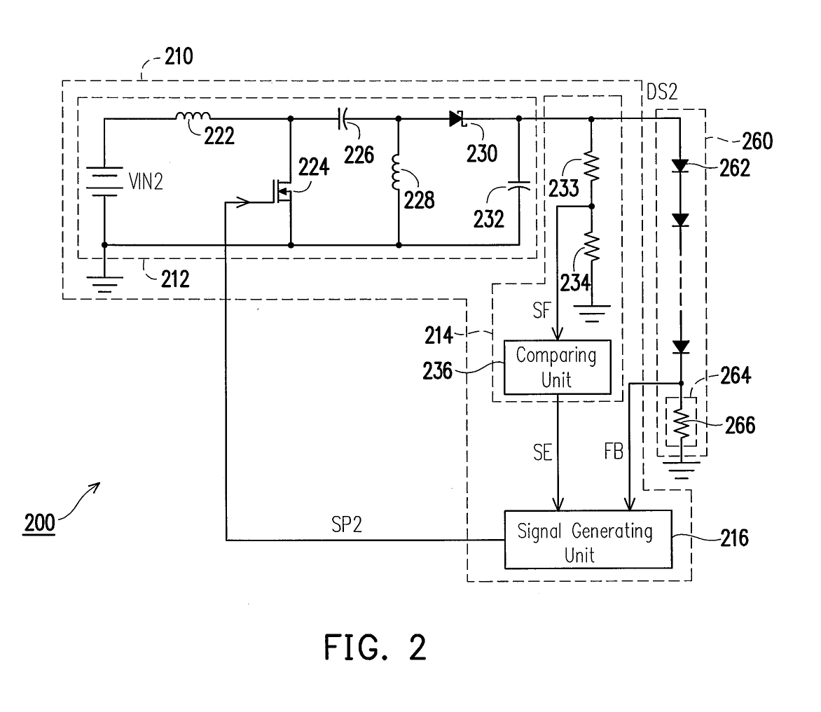

FIG. 2 is a circuit diagram of a light-emitting apparatus according to a preferred embodiment of the present invention. Referring to FIG. 2, the light-emitting apparatus 200 provided by the present invention includes a driving circuit 210 and a light source module 260. In the present invention, the driving circuit 210 generates a driving signal DS2 to drive the light source module 260 according to an input voltage VIN2. In this embodiment, the light source module 260 includes at least an LED.

In this embodiment, the light source module 260 includes a plurality of (or at least one) LEDs 262. A cathode terminal of each LED is coupled to an anode terminal of next LED, and an anode terminal of the first LED is coupled to the driving circuit 210 to receive the driving signal DS2.

In some embodiments, the light source module 260 further includes a load detector 264 for grounding a cathode of the last LED. The load detector 264 is used to detect an operating current flowing through the LED 262, convert the current into a feedback signal FB in the form of voltage, and then transmit it to the signal generating unit 216. In this embodiment, the load detector 264 can be realized by a resistor 266. One terminal of the resistor 266 is grounded, and another terminal is coupled to a cathode terminal of the last LED.

The driving circuit 210 includes a power conversion module 212, a protection module 214, and a signal generating unit 216. In this embodiment, the power conversion module 212 outputs a driving signal DS2 to drive the light source module 260, and the protection module 214 detects the potential of the driving signal DS2 and outputs a protection signal SE. The state of the protection signal SE is determined by the potential of the driving signal DS2.

Furthermore, the signal generating unit 216 generates and transmits a PWM signal SP2 to the power conversion module 212 according to the received feedback signal FB generated by the light source module 260 and the protection signal SE output by the protection module 214. Thus, the power conversion module 212 can step up or step down the potential of the input voltage VIN2 to generate the driving signal DS2 according to the duty cycle of the PWM signal SP2.

The power conversion module 212 mainly includes inductors 222 and 228, a switch 224, capacitors 226 and 232, and a diode 230. In this embodiment, one terminal of the inductor 222 is coupled to the input voltage VIN2, and another terminal is coupled to the switch 224. Thus, the switch 224 determines whether or not to couple the inductor 222 to ground according to the PWM signal SP2. In a preferred embodiment, the switch 224 can be realized by the NMOS transistor, which has a first source/drain terminal coupled to the inductor 222 and the capacitor 226, a gate terminal receiving the PWM signal SP2, and a second source/drain terminal grounded.

Furthermore, one terminal of the capacitor 226 and the inductor 222 are coupled to the switch 224 together, another terminal of the capacitor 226 is coupled to an anode terminal of the diode 230 and one terminal of the inductor 228, and another terminal of the inductor 228 is grounded. In this embodiment, the diode 230 can be a Schottky diode, which has a cathode terminal coupled to one terminal of the capacitor 232, and the other terminal of the capacitor 232 is grounded.

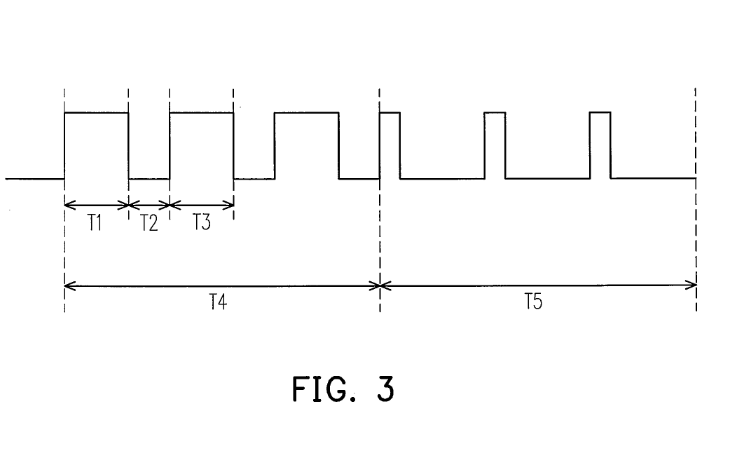

FIG. 3 is a timing diagram of a PWM signal according to a preferred embodiment of the present invention. Referring to FIGS. 2 and 3 together, if the power conversion module 212 is in a stable operating state, during a time interval T1, the PWM signal SP2 is in a high potential state, so that the switch 224 is turned on. At this time, the input voltage VIN2 charges the inductor 222 to store energy in the inductor 222, and the capacitor 226 releases the stored energy via the switch 224, so that the energy is stored in the inductor 228. The diode is in an OFF state, and the capacitor 232 releases the energy to drive the light source module 260 to emit lights.

During a time interval T2, the PWM signal SP2 is in a low potential state, so that switch 224 is turned off. At this time, the inductors 222 and 228 releases energy to drive the light source module 260 to emit lights (meanwhile the diode 230 is in an ON state), and the capacitors 226 and 232 stores the energy released by the inductors 222 and 228 to stabilize the voltage provided to the driving signal DS2 of the light source module 260.

During the time interval T3, the PWM signal SP2 is converted to be in a high potential again, and thus the switch 224 is turned on again. At this time, the inductors 222 and 228 are in a power-storing state again, and the capacitors 226 and 232 are in an energy-releasing state, wherein the capacitor 232 releases the stored electrical energy so as to continuously output the driving signal DS2.

In the present invention, the ratio of the potential of the driving signal DS2 to the potential of the input voltage VIN2 can be expressed by the following formula:

$$\frac{D}{1 - D}$$

where D denotes the duty cycle of the PWM signal SP2. In other words, when the duty cycle of the PWM signal SP2 is greater than 50% (e.g. the duty cycle of the PWM signal SP2 in FIG. 3 during the time interval T4), the power conversion circuit 212 enhances the potential of the input voltage VIN2. Comparatively, when the duty cycle of the PWM signal SP2 is smaller than 50% (e.g. the duty cycle of the PWM signal SP2 in FIG. 3 during a time interval T5), the power conversion circuit 212 reduces the potential of the input voltage VIN2. Therefore, the present invention only needs to adjust the cycle of the PWM signal to satisfy the requirements for different voltages of the light source modules.

Referring to FIG. 2 again, the protection module 214 includes a voltage detector circuit constituted by resistors 233 and 244 and a comparing unit 236. The resistors 233 and 234 are connected in series, and one terminal is coupled to the cathode terminal of the diode 230 while another terminal is grounded. In this embodiment, the potential of the coupling node of the resistors 233 and 234 is transmitted to the comparing unit 236 for sending out a voltage detection signal SF. When receiving the voltage detection signal SF, the comparing unit 236 outputs the protection signal SE to the signal generating unit 216 according to the voltage detection signal SF.

In this embodiment, the voltage detection signal SF is used to indicate the potential of the driving signal DS2. Therefore, when receiving the voltage detection signal SF, the comparing unit 236 determines whether the potential of the driving signal DS2 is greater than a first preset value or smaller than a second preset value according to the voltage detection signal SF.

If the potential of the driving signal DS2 is greater than a first preset value or smaller than a second preset value, it indicates that the driving circuit 210 operations abnormally. Therefore, the comparing unit 236 outputs the protection signal SE with a first level to interrupt the operation of the signal generating unit 216, so that the signal generating unit 216 stops outputting a PWM signal SP2 to the power conversion module 212, and thus the power conversion module 212 stops outputting the driving signal DS2 to the light source module 260. Thus, the damage to the light source module 260 caused by the abnormal operation of the driving circuit 210 can be avoided.

Comparatively, if the potential of the driving signal DS2 is between the first preset value and the second present value, it indicates that the driving circuit 210 operates normally. At this time, the comparing unit outputs (or stops outputting) the protection signal SE with a second level, and thus the signal generating unit 216 continuously generates and transmits the PWM signal SP2 to the power conversion module 212. The first level is higher than the second level.

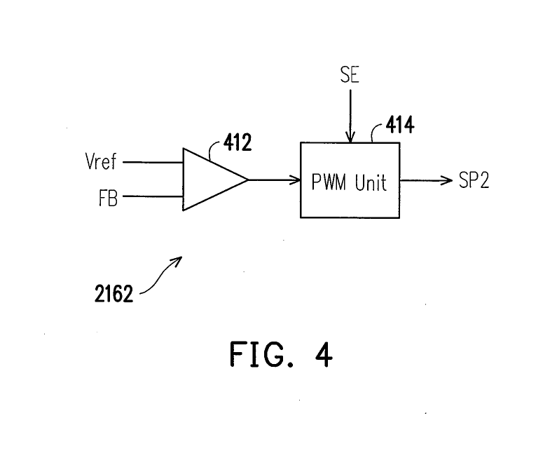

FIG. 4 is a circuit diagram of a comparing unit according to a preferred embodiment of the present invention. Referring to FIG. 4, the comparing unit 2162 is applicable to the signal generating unit 216 in FIG. 2. The comparing unit 2162 includes an error amplifier 412 and a pulse width modulation (PWM) unit 414. In this embodiment, the error amplifier 412 is used to receive, for example, the feedback signal FB output by the light source module 260 in FIG. 2 and a reference voltage Vref. After receiving the feedback signal FB, the error amplifier 412 compares the feedback signal FB with the reference voltage Vref and then outputs a compensating signal to the PWM unit 414.

The PWM unit 414 is used to generate the PWM signal SP2. As described above, the PWM unit 414 determines whether or not to output the PWM signal SP2 normally according to the protection signal SE. Furthermore, the PWM unit 414 adjusts the duty cycle of the PWM signal SP2 according to the compensating signal of the error amplifier 412.

When the potential of the feedback signal FB is smaller than that of the reference voltage Vref, the PWM unit 414 can increase the duty cycle of the PWM signal SP2. Comparatively, when the potential of the feedback signal FB is greater than that of the reference voltage Vref, the PWM unit 414 can reduce the duty cycle of the PWM signal SP2. Thus, the present invention can effectively control, for example, the light source module 260 in FIG. 2.

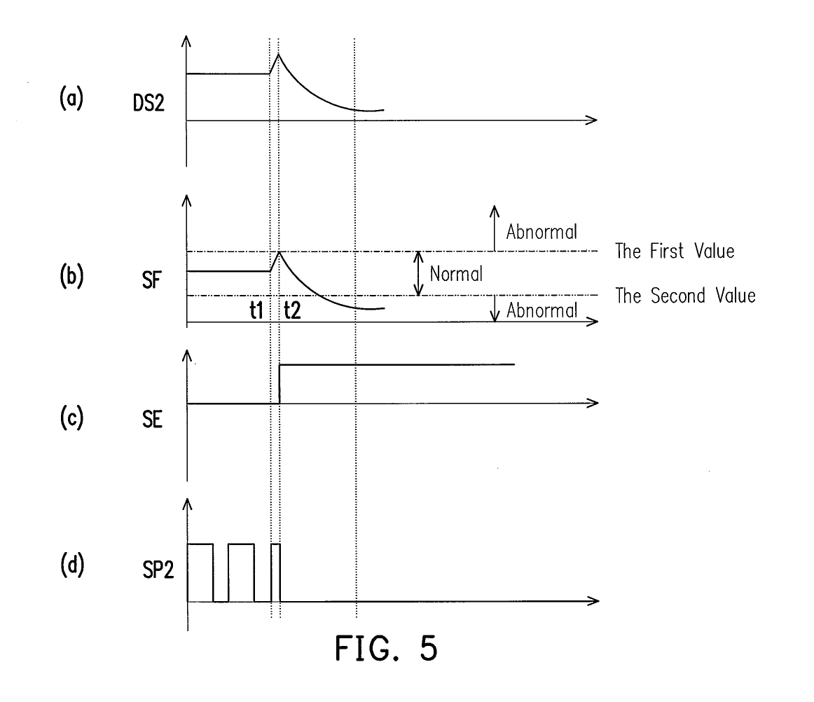

FIG. 5 is a timing diagram of a protection function according to a preferred embodiment of the present invention. Before a time point t1, the driving circuit 210 stably provides the driving signal DS2, and the protection signal SE is at the second level. At the time point t1, the circuit is abnormal, thus resulting in a sudden increase of the level of the driving signal DS2. In the interval between the time points t1 and t2, the level of the feedback signal FB increases, and the signal generating unit 216 reduces the duty cycle of the PWM signal SP2 according to the feedback signal FB. At the time point t2, the voltage detection signal SF is higher than a first value (i.e. the driving signal DS2 is higher than a first preset value), and the protection signal SE changes into the first level and is locked, such that the signal generating unit 216 stops outputting the PWM signal SP2. After changing from the second level to the first level, the protection signal SE can also be unlocked. When the voltage detection signal SF returns between the first value and the second value, the signal generating unit 216 outputs the PWM signal SP2 again. Or, after lasting a preset time, when the voltage detection signal SF maintains greater than the first value (or smaller than the second value) or so, the protection signal SE changes into the first level and is locked. The protection signal SE locked at the first level must be reset to release the locking state.

In view of the above, in the present invention, the power conversion module can step up or step down the potential of the input voltage according to the duty cycle of the PWM signal. Therefore, the present invention may be applied to the light source loads requiring for different voltages. Furthermore, as the present invention adopts the protection module, the load damage can be avoided when an abnormal operation occurs in the present invention.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A driving circuit of a light-emitting diode (LED), comprising:
a first inductor, having a first terminal coupled to an input voltage;
a first capacitor, having a first terminal coupled to a second terminal of the first inductor;
a switch, for determining whether or not to couple the second terminal of the first inductor to ground according to a PWM signal;
a second inductor, having a first terminal coupled to a second terminal of the first capacitor and a second terminal grounded;
a diode, having an anode terminal coupled to the second terminal of the first capacitor;
a second capacitor, having a first terminal coupled to a cathode terminal of the diode and a light source module to provide a driving signal to the light source module, and a second terminal grounded, wherein the light source module comprises at least an LED;
a load detector, for detecting a current of the light source module to output a feedback signal; and
a signal generating unit, coupled to the load detector, for generating the PWM signal according to the feedback signal.

2. The driving circuit of the LED as claimed in claim 1, further comprising a protection module coupled to the signal generating unit and determining a state of a protection signal according to a potential of the driving signal, so that the signal generating unit determines whether or not to generate the PWM signal according to the protection signal.

3. The driving circuit of the LED as claimed in claim 2, wherein when the potential of the driving signal is greater than a first preset value or smaller than a second preset value, the signal generating unit stops outputting the driving signal.

4. The driving circuit of the LED as claimed in claim 3, wherein the signal generating unit comprises:
an error amplifier, for comparing the feedback signal and a reference voltage and generating a compensating signal; and
a PWM unit, for generating the PWM signal according to a state of the protection signal and the compensating signal.

5. The driving circuit of the LED as claimed in claim 4, wherein the switch comprises an NMOS transistor having a first source/drain terminal coupled to the second terminal of the first capacitor, a gate terminal for receiving the PWM signal, and a second source/drain terminal coupled to ground.

6. The driving circuit of the LED as claimed in claim 4, wherein the diode is a Schottky diode

7. The driving circuit of the LED as claimed in claim 2, wherein when the potential of the driving signal maintains greater than a first preset value or smaller than a second preset value for a preset time, the signal generating unit stops outputting the driving signal.

8. The driving circuit of the LED as claimed in any one of claims 7, wherein the signal generating unit comprises:
an error amplifier, for comparing the feedback signal and a reference voltage and generating a compensating signal; and
a PWM unit, for generating the PWM signal according to a state of the protection signal and the compensating signal.

9. The driving circuit of the LED as claimed in claim 8, wherein the switch comprises an NMOS transistor having a first source/drain terminal coupled to the second terminal of the first capacitor, a gate terminal for receiving the PWM signal, and a second source/drain terminal grounded.

10. The driving circuit of the LED as claimed in claim 8, wherein the diode is a Schottky diode.

11. The driving circuit of the LED as claimed in claim 2, wherein the protection module comprises:
a voltage detector, for detecting a potential of the driving signal; and
a comparing unit, for comparing the potential of the driving signal with a first value and a second value and outputting the protection signal.

12. The driving circuit of the LED as claimed in claim 11, wherein the voltage detector comprises:
a first resistor, having a first terminal for receiving the driving signal and a second terminal coupled to the comparing unit; and
a second resistor, having a first terminal coupled to the second terminal of the first resistor and a second terminal grounded.

13. A light-emitting apparatus, comprising:
a light source module, comprising at least an LED;
a power conversion module, for stepping up or stepping down an input voltage to a driving signal to drive the light source module according to a duty cycle of the PWM signal; and
a protection module, for determining a state of the protection signal to control the operation of the power conversion module according to a potential of the driving signal.

14. The light-emitting apparatus as claimed in claim 13, wherein when the potential of the driving signal is greater than a first preset value or smaller than a second preset value, the protection module outputs the protection signal to control the power conversion module to stop outputting the driving signal.

15. The light-emitting apparatus as claimed in claim 14, wherein the protection module comprises:
a voltage detector, for detecting a potential of the driving signal; and
a comparing unit, for outputting the protection signal according to the potential of the driving signal and a comparison result between the first preset value and the second preset value.

16. The light-emitting apparatus as claimed in claim 15, wherein the voltage detector comprises:
a first resistor, having a first terminal for receiving the driving signal and a second terminal coupled to the comparing unit; and
a second resistor, having a first terminal coupled to the second terminal of the first resistor and a second terminal grounded.

17. The light-emitting apparatus as claimed in claim 11, wherein when the potential of the driving signal maintains greater than a first preset value or smaller than a second preset value for a preset time, the protection module outputs the protection signal to control the power conversion module to stop outputting the driving signal.

18. The light-emitting apparatus as claimed in 17, wherein the protection module comprises:
a voltage detector, for detecting a potential of the driving signal; and
a comparing unit, for outputting the protection signal according to the potential of the driving signal and a comparison result between the first preset value and the second preset value.

19. The light-emitting apparatus as claimed in claim 18, wherein the voltage detector comprises:
a first resistor, having a first terminal for receiving the driving signal and a second terminal coupled to the comparing unit; and
a second resistor, having a first terminal coupled to the second terminal of the first resistor and a second terminal grounded.
